(19) United States
(12) Patent Application Publication
(10) Pub. No.: US 2006/0017562 A1
(43) Pub. Date: Jan. 26, 2006

(54) Distributed, roadside-based real-time ID recognition system and method

(76) Inventor: Aaron D. Bachelder, Irvine, CA (US)

Correspondence Address: CHRISTIE, PARKER & HALE, LLP, PO BOX 7068, PASADENA, CA, 91109-7068, US

(21) Appl. No.: 11/186,188

(22) Filed: Jul. 20, 2005

Related U.S. Application Data
(60) Provisional application No. 60/589,659, filed on Jul. 20, 2004.

(51) Int. Cl. G08B 1/00; G08B 23/00; G05B 19/00; G06K 9/00

(52) U.S. Cl. 340/531; 340/573.4; 340/5.81; 382/105

(57) ABSTRACT

A comprehensive ID recognition system including mobile units equipped with sensor detection hardware for obtaining sensor data. The sensor data is forwarded to a nearby intersection controller equipped with sensor processing software. The intersection controller processes the sensor data for ID recognition, and transmits real-time alerts to the mobile unit if the recognized ID has been flagged for such alerts. The mobile ID recognition data and/or analysis results may then be stored on a local, city, or regional basis, in varying levels of detail.

### CROSS-REFERENCE TO RELATED APPLICATION(S)

This application claims the benefit of U.S. Provisional Application No. 60/589,659, filed on Jul. 20, 2004 (attorney docket 53468), the content of which is incorporated herein by reference.

### BACKGROUND OF THE INVENTION

Identification (ID) recognition encompasses a wide range of detection technologies that come in many forms and serve various functions. Included in these technologies are fingerprinting, eye scanning, facial recognition, voice recognition, license-plate recognition, ear identification, and the like. Within the homeland security arena, ID recognition can extend to include foreign substance detection or radiation detection. The need for real-time ID recognition has taken on new significance in recent years with concerns over terrorism.

An exemplary ID recognition is license plate recognition. Many license plate reading systems have been developed and used for traffic enforcement and parking violations. For example, license plate reading systems are often incorporated into red-light running camera systems at street intersections. These systems often detect red-light running vehicles using in-situ measurement techniques, such as object recognition. Once triggered, the systems often use an advanced form of optical-character recognition (OCR) to detect and translate an offender's license plate. A ticket is then semi-automatically issued (with human approval) to the driver's residence.

One of the major shortcomings of current license plate enforcement systems is that they are expensive, often requiring tens of thousands of dollars per installation. These systems are also fairly complex and often require significant on-site computational, data archival, and network communication capabilities. These requirements generally call for fixed location installation configurations. The requirements for current license plate enforcement systems also generally exist for other ID recognition systems, limiting the effectiveness and scope of such systems.

Accordingly, what is desired is a relatively inexpensive, mobile ID recognition system and method that allows real-time or near real-time ID recognition. Such a system should extend the effectiveness, scope, and coverage of existing ID recognition technology.

### SUMMARY OF THE INVENTION

According to one embodiment, the present invention is directed to a method for identification (ID) recognition via a mobile unit equipped with sensor detection hardware and an intersection controller equipped with sensor processing software. The mobile unit's sensor detection hardware obtains sensor data. Location information for the mobile unit is then determined in response to the obtaining of the sensor data. The location information may be determined via a global positioning system. The mobile unit wirelessly transmits the obtained sensor data and the location information to one or more intersection controllers. A particular intersection controller wirelessly receives the sensor data and the location information transmitted by the mobile unit. The sensor processing software at the particular intersection controller analyzes the received sensor data and outputs ID recognition information. The output ID recognition information is stored in a data store in association with the location information.

According to one embodiment, the sensor data is a license plate image or a facial image.

According to one embodiment, the intersection controller controls traffic signals at the intersection.

According to one embodiment, the sensor detection hardware is programmed for continuously obtaining and forwarding the sensor data to the intersection controller under predetermined conditions.

According to one embodiment, the analyzing of the received sensor data includes searching a notification criteria database for a match of the sensor data with stored ID indicia, and wirelessly transmitting a notification to the mobile unit responsive to the match. The stored ID indicia may be a list of license plate numbers. The notification criteria database may also store violations associated with each stored license plate. The notification to the mobile units may then include the license plate number matching the sensor data and the associated violation.

According to another embodiment, the present invention is directed to a method for ID recognition via a mobile unit equipped with sensor detection hardware and a roadside controller equipped with sensor processing software. The sensor detection hardware of the mobile unit obtains the sensor data and wirelessly transmits to one or more roadside controllers. A particular roadside controller wirelessly receives the sensor data transmitted by the mobile unit, invokes the sensor processing software for searching a notification criteria database for a match of the sensor data with stored ID indicia, and wirelessly transmits a notification to the mobile unit responsive to the match.

The roadside controller may be an intersection controller controlling traffic signals at the intersection.

According to another embodiment, the present invention is directed to an ID recognition system that includes a mobile unit and an intersection controller in communication with the mobile unit. The mobile unit includes a sensor detection hardware obtaining sensor data; a global positioning system unit obtaining location of the mobile unit in response to the obtained sensor data; and a wireless interface for wirelessly transmitting the obtained sensor data and the location information. The intersection controller includes a wireless interface for wirelessly receiving the sensor data and the location information transmitted by the mobile unit; a processor; a memory operably coupled to the processor and storing sensor data processing instructions, the processor being operable to execute the sensor data processing instructions and output ID recognition information; and a data store storing the ID recognition information in association with the location information.

According to another embodiment, the present invention is directed to an intersection controller wirelessly receiving sensor data obtained by a mobile unit. The intersection controller includes a wireless interface for wirelessly communicating with the mobile unit. The intersection controller also includes a notification criteria database storing a plurality of ID indicia. The intersection controller further includes a processor and a memory operably coupled to the processor and storing program instructions therein, the processor being operable to execute the program instructions, the program instructions including controlling traffic signals based on predetermined conditions; analyzing the sensor data transmitted by the mobile unit; searching the notification criteria database for a match of the sensor data with the stored ID indicia; and wirelessly transmitting a notification to the mobile unit responsive to the match.

It should be appreciated, therefore, that the present invention provides for a mobile ID recognition and data archival system that leverages on the distributed computing architecture of existing traffic management infrastructure providing connectivity on an intersection-to-intersection, city-wide, regional, or nationwide basis. By distributing the processing, analyzing, and storing of the sensor data to preexisting devices, cost, complexity, and maintenance of the mobile units may be reduced.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a block diagram of a distributed, roadside-based, real-time ID recognition system according to one embodiment of the invention;

FIG. 2 is a more detailed block diagram of the distributed, roadside-based, real-time ID recognition system of FIG. 1 according to one embodiment of the invention;

FIG. 3 is a flow diagram of a process executed by a mobile unit for mobile ID recognition according to one embodiment of the invention;

FIG. 4 is a flow diagram of a process executed by a analysis/decision software of a roadside controller according to one embodiment of the invention;

FIG. 5 is a schematic block diagram of an enforcement vehicle configured for license plate recognition according to one embodiment of the invention;

FIG. 6 is a hardware layout of the enforcement vehicle of FIG. 5 according to one embodiment of the invention; and

FIG. 7 are flow diagrams of the processes executed by enforcement vehicles, roadside controllers, and city or regional centers for real-time, in-vehicle license plate recognition according to one embodiment of the invention.

### DETAILED DESCRIPTION

In general terms, this invention is directed to a comprehensive ID recognition system that leverages on the distributed computing architecture of existing traffic management systems to allow real-time ID or event recognition (collectively referred to as ID recognition) by mobile units. The types of ID recognition achieved by the present system include, but are not limited to fingerprint recognition, retinal detection, facial recognition, voice recognition, license-plate recognition, ear identification, and the like.

In conducting the recognition, a mobile unit obtains sensor data and forwards the sensor data to an existing roadside controller, such as, for example, an existing traffic controller at a nearby intersection. The roadside controller processes the sensor data for ID recognition, and further transmits real-time alerts to the mobile unit if the recognized ID has been flagged for such alerts. The mobile ID recognition data and/or analysis results may be stored on a local, city, or regional basis, in varying levels of detail. In this manner, the mobile unit need only be equipped to capture and transmit the sensor data, leaving the computationally expensive processing and data archival requirements to preexisting controllers and/or city or regional centers at fixed locations.

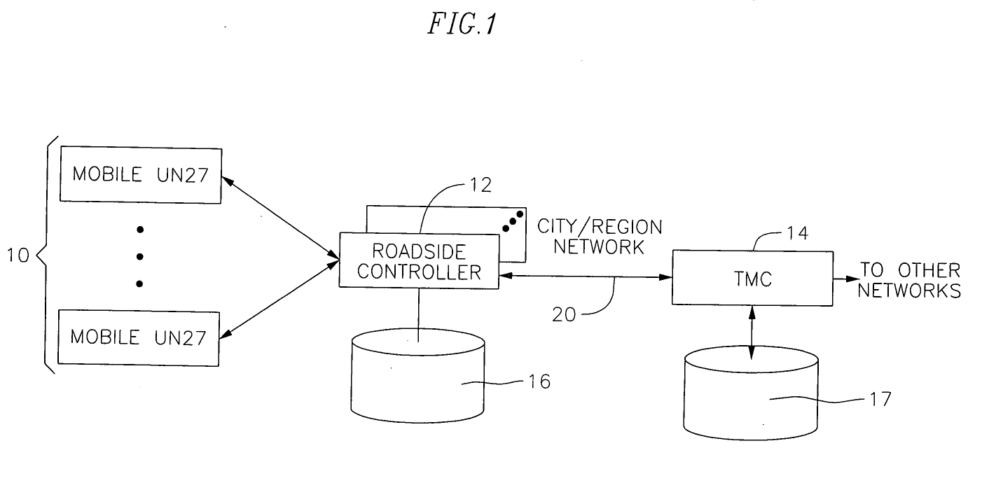

FIG. 1 is a block diagram of a distributed, roadside-based, real-time ID recognition system according to one embodiment of the invention. The system includes one or more mobile units 10 wirelessly communicating with one or more distributed roadside controllers 12. The mobile units may be first responder (emergency) vehicles, cellular phones, personal digital assistants, or other types of mobile device conventional in the art.

According to one embodiment of the invention, the roadside controllers 12 are part of a pre-existing roadside infrastructure that uses and manages these controllers for traffic control. For example, the roadside controllers 12 may take the form of traffic controllers located at various intersections and controlling traffic signals at these intersections based on predetermined conditions (e.g. time of day). Such controllers may already be equipped with software and hardware (processor, memory, and related circuitry) for controlling the traffic signals and providing other types of traffic control functionality, such as, for example, red-light running functionality that detects vehicles running the red light. Comprehensive ID recognition functionality including sensor data processing, matching, and reporting functionality, are added on top of any such preexisting functionality for extending the use of the roadside controllers. The offloading of such ID recognition functionality and the re-use of existing hardware in roadside controllers allows the mobile units to remain simple and affordable.

Each roadside controller is coupled to a local storage device 16 such as, for example, a hard drive or drive array, configured with one or more databases storing information used for real-time ID recognition and notification. Such databases include search criteria and ID matches, and optionally, streaming (real-time transmitted) raw sensor data obtained by the mobile units, as well as ID recognition analysis/results. In this manner, ID recognition and notification information may be locally maintained by the roadside controller for the particular intersection or roadside.

The wireless communication between the mobile units and the roadside controller may be via any existing wireless technology known in the art, such as, for example, Bluetooth technology, 802.11 Wi-Fi technology, or the like. In a metropolitan city where roadside controller locations are geographically dense, the roadside controllers provide redundant, high-bandwidth, and robust connections for the mobile units.

Each roadside controller 12 is coupled to one or more traffic/emergency management centers (TMCs) 14 over a local area network (LAN), wide area network (WAN), or the public Internet. The TMCs may in turn be coupled to other networks, such as, for example, regional and national centers and repositories for nationwide storing and dissemination of information.

The TMC 14 receives information from the roadside controllers 12 via a city and/or regional network 20, and stores the information in a TMC storage device 17, such as, for example, a hard drive or drive array. The information provided by the roadside controllers 12 may include all or a portion of the mobile ID recognition data and/or analysis results. In this manner, real-time, historical logging of information provided by the roadside controllers may be centrally maintained for a particular area, such as, for example, a city. The TMC storage device 17 also stores roadway, intersection, and other match criteria information for the area controlled by the TMC.

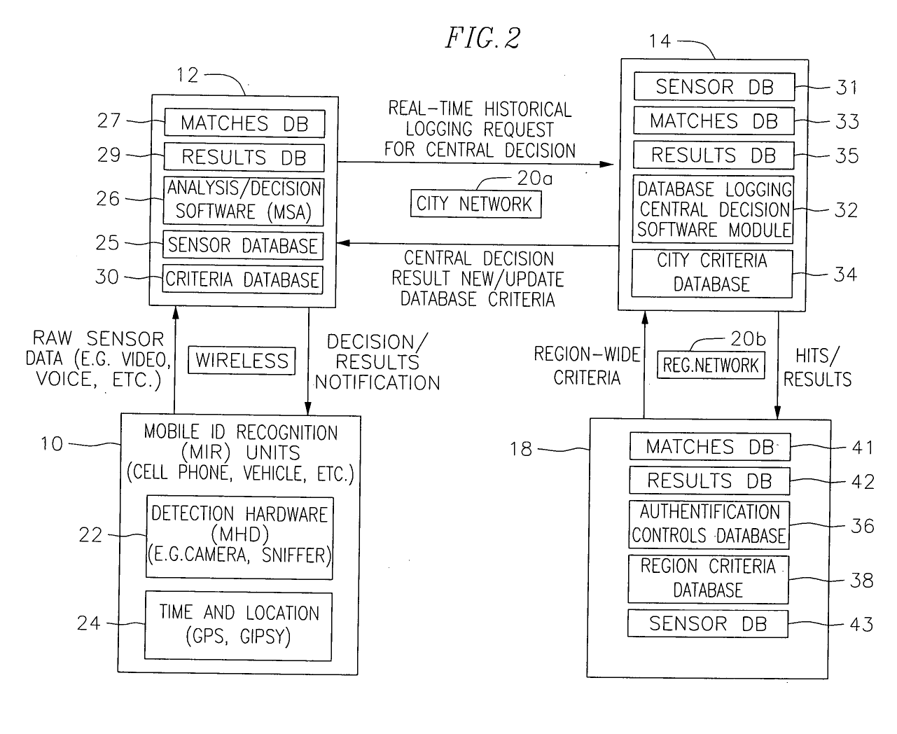

FIG. 2 is a more detailed block diagram of the distributed, roadside-based, real-time ID recognition system according to one embodiment of the invention. Each mobile unit 10 is equipped with detection hardware 22 that enables sampling of raw sensor data for the ID recognition. The particular type of detection hardware used will depend on the sensor data that is to be obtained. For example, the detection hardware may be a video or still camera and image processing hardware, for facial, retinal, and license plate recognition. On the other hand, the detection hardware may be a microphone for voice recognition, or “sniffers” (spectroscopy) for foreign substance/gas detection.

Also included in the mobile unit 10 is a time and location unit 24 for marking an obtained sensor data with a time and date in which the data was obtained, and the location where the data was obtained. Because the measurement of the sensor data is by units that are inherently mobile, the sensor data is not bound to an intersection or other fixed location. Thus, the particular position of the mobile unit 10 at the time of the measurement of the sensor data is obtained and associated with the sensor data.

In its most basic configuration, the time and location unit 24 takes the form of a conventional global positioning system (GPS) unit which measures location using latitude and longitude coordinates. The GPS unit may be augmented by additional position detection functionality, such as, for example, dead-reckoning or map-matching functionality for ensuring accuracy even when the GPS satellites go out-of-view (e.g. in a tunnel).

According to one embodiment of the invention, the time and location unit 24 includes enhanced positioning technology such as, for example, GIPSY (GPS-Inferred Positioning System and Orbit Analysis Simulation Software). GIPSY is a GPS-derivative positioning system developed by NASA that provides upwards of 6-cm accuracy for mobile units in vehicles and on people. The additional level of accuracy may be critical for such types of ID recognition as toxic substance detection. In such cases, centimeter-level accuracy may make the difference in actually finding the source of a threat in a thorough follow-up investigation.

Each mobile unit 10 wirelessly communicates with a nearby roadside controller 12 for transmitting the raw sensor data obtained by the detection hardware 22, along with the associated time/date and location information. The mobile unit also receives notifications based on the processed sensor data from the roadside controller 12. In some situations where raw data may require more time-intensive analysis, this data exchange may occur over a longer time window that may span several roadside controllers at several intersections. The initial controller that receives the raw data may process the sample and then forward possible results to downstream intersections on the network (which then forward results to the mobile unit).

According to one embodiment of the invention, the road-side controller 12 includes a processor and associated memory storing analysis/decision software 26. The analysis/decision software 26 takes the raw sensor data communicated by the mobile unit 10 and processes the data for ID recognition. In one embodiment of the invention, the streaming raw sensor data may be stored in a local sensor database 25 with or without the time/date and location information transmitted by the mobile unit 10.

In a license recognition scenario, the analysis/decision software 26 includes OCR software for detecting and translating the streaming raw sensor data into a license plate number. In a foreign substance/gas detection scenario, the analysis/decision software 26 may include absorption spectrum analysis software for identifying foreign substances and/or gas. Again, because the analysis is distributed to the roadside controllers 10 instead of the mobile units, the mobile units may be kept simple and inexpensive.

The analysis/decision software 26 makes use of data stored in a local candidate/criteria database 30 for the ID recognition and notification. For example, the criteria database may store a plurality of ID indicia to be matched against the sensor data. In the context of a license plate recognition system, the ID indicia are license plates (for the city, state, or region) which have warrants or similar alerts. In a facial recognition scenario, the ID indicia are full or partial face digital “footprints.” The local criteria database 30 may be updated periodically or on a real-time or near-real basis, with changes flowing down the hierarchy from city/regional centers to TMCs, and from the TCMs to intersections.

According to one embodiment of the invention, restrictions are placed on one or more fields of the local criteria database 30 so as to limit liability or privacy invasion issues. For instance, for license plate criteria databases storing names or other details associated with the license plates for which alerts or warrants have been placed, the notification of a matching license plate may only include the matching license plate number and the associated violation, but not the name or other details of the owner of the vehicle. An officer in the field receiving the notification may then obtain any additional information through standard, established human-to-human processes.

A local matches database 27 stores information upon a successful match of a recognized ID against criteria in the local criteria database 30. For example, in the license plate recognition scenario, the local matches database 27 may store the identified license plate number along with an image of the license plate, a time/date and location in which the license plate was detected, and the violation associated with the license plate.

In one embodiment of this invention, all ID analysis results (and respective analysis parameters) are stored in a separate local analysis/results database 29, regardless of whether the analysis successfully matched an entry in the local criteria database 30. In the license plate recognition scenario, the results/analysis database may store a list of all recognized license plate numbers. In a facial recognition scenario, the results/analysis database may store full or partial face digital “footprints.”The use of a local analysis/results database 29 will depend on local privacy laws as the system is aimed to store all analysis and results, not just positive matches. The local analysis/results database 29 may later be used for post-processing, especially where more advanced, computational intensive processing may be required, or for re-processing by future, yet undeveloped analysis methods or technology. The local analysis/results database 29 may also be used to investigate crimes that have yet to happen and/or have yet to be added to the local criteria database 30.

The roadside controller 12 communicates with the TMC 14 over a city network 20a. According to one embodiment of the invention, the TMC 14 includes a processor and associated memory storing a TMC logging and decision software 32. The TMC software 32 receives ID recognition matches from one or more roadside controllers 12, and logs the data in a TMC aggregate matches database 33. Optionally, the TMC software 32 receives analysis/results from one or more roadside controllers 12, and logs this data in a TMC aggregate analysis/results database 35.

In one embodiment of the invention, the TMC software 32 may also receive real-time raw sensor data forwarded by one or more controllers 12, including time/date and location information, and perform TMC-based analysis equivalent to the analysis/detection software 26 on roadside controllers 12. This TMC software 32 may replace or supplement roadside controller analysis/decision software 26. Such raw data may also be stored in a TMC aggregate raw sensor database 31.

The TMC aggregate sensor database 31, TMC aggregate matches database 33, and TMC aggregate analysis/results database 35 may contain the same or a filtered version of the data respectively stored in the local sensor database 25, local matches database 27, and local results database 29, of each roadside controller 12 associated with the TMC. Thus, the TMC may aggregate ID recognition and criteria match data on, for example, a city-wide basis, while each roadside controller 12 aggregates the data on, for example, a street intersection basis.

According to one embodiment of the invention, the decision as to whether a notification should be transmitted to a mobile unit is handled by the TMC software 32 instead of locally by the roadside controller. In this embodiment, the roadside controller transmits a request for central decision by the TMC software 32 if ID recognition has been successful. The TMC software receives the request, and in response, may further analyze the data with more detailed information from the TMC criteria database 34. The TMC software may also require human authorization. If notification is authorized, the TMC software transmits the results of the match to the roadside controller, which then wirelessly notifies the mobile unit of the criteria match and transmits all or a portion of the match information to the mobile unit.

The TMC criteria database 34 maintains the associated roadside controllers' criteria databases 30, and may store more extensive identifying and description criteria than the roadside controller criteria databases. When updates are made to the TMC criteria database 34 by external law enforcement systems or official persons, such updates are filtered and transmitted in real-time or near real-time to the roadside controllers 12 managed by the TMC. Alternatively, the updates may be collected and transmitted to the roadside controllers on a periodic basis. In response to receipt of the update data, the roadside controllers update their respective local criteria databases 30 with the new or changed information. In this manner, information at the various roadside controllers may be kept up-to-date.

According to one embodiment of the invention, regional and/or national centers may also provide information and get the benefit of the mobile, real-time ID recognition provided by the described system. Thus, in the embodiment illustrated in FIG. 2, a regional controller 18 is coupled to one or more TMCs 14 for which it is in charge. The regional controller 18 receives ID recognition matches forwarded by one or more TMCs 14, and logs the data in a regional aggregate matches database 41. Optionally, the regional controller 18 receives analysis/results forwarded by one or more TMCs 14, and logs this data in a regional aggregate analysis/results database 42.

In one embodiment of the invention, the regional controller 18 may also receive real-time raw sensor data forwarded by one or more TMCs 14, including time/date and location information, and perform TMC-based analysis equivalent to the analysis/detection software 26 on the roadside controllers 12. The regional-based analysis may replace or supplement the TMC decision software 32 or roadside controller analysis/decision software 26. Such raw data may also be stored in a regional aggregate raw sensor database 43.

The regional aggregate sensor database 43, regional aggregate matches database 41, and regional aggregate analysis/results database 42 may contain the same or a filtered version of the data respectively stored in the TMC sensor database 31, TMC matches database 33, and TMC results database 35, of each TMC 14 associated with the regional controller 18. Thus, the regional controller 18 aggregates ID recognition and criteria match data on, for example, a regional basis, while each TMC aggregates the data on, for example, a city-wide basis, and each roadside controller 12 aggregates the data on, for example, a street intersection basis.

According to one embodiment of the invention, an authentication controls database 36 stores user access permission for layered access to one or more databases maintained by the regional controller 18, TMC 14, and/or roadside controller 12. The data stored in the various databases may be accessed at different levels of detail based on the access permission that is granted. This ensures proper balance between privacy, security, and awareness for the users of the system.

The regional criteria database 38 maintains the associated TMC criteria databases 34, and may store more extensive identifying and description criteria than the TMC criteria databases. When updates are made to the regional criteria database 38 by external law enforcement systems or official persons, such updates are filtered and transmitted in real-time or near real-time to the associated TMCs 14, which then forward the updates to the associated roadside controllers 12. Alternatively, the updates may be collected and transmitted on a periodic basis.

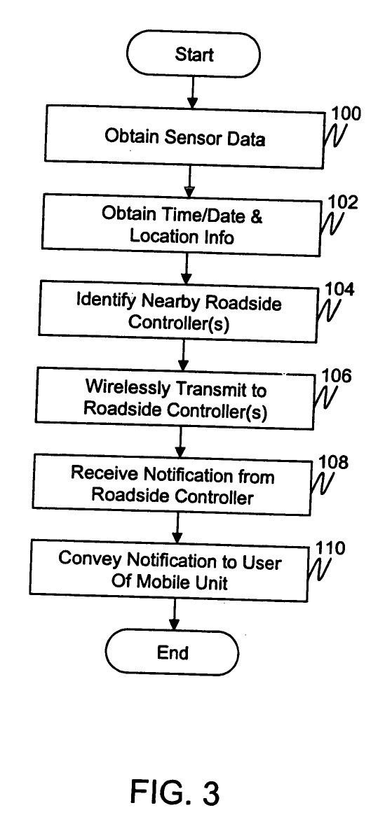

FIG. 3 is a flow diagram of a process executed by the mobile unit for the mobile ID recognition according to one embodiment of the invention. The process may be described in terms of a software routine stored in memory and executed by a processor included in the mobile unit. A person of skill in the art should recognize, however, that the routine may be executed via hardware, firmware (e.g. via an ASIC), or in any combination of software, firmware, and/or hardware. Furthermore, the steps of the process may be executed in the indicated order or in any other order recognized by a person of skill in the art.

In step 100, the mobile unit invokes the detection hardware 22 and obtains sensor data. This may be done manually via a user of the mobile unit, or automatically at predetermined times or under predetermined conditions, upon such programming of the detection hardware.

In step 102, the time and location unit 24 is invoked in response to the obtaining of the sensor data. The time and location unit 24 bundles the sensor data with a time/date in which the sensor data was obtained, and location of the mobile unit at the identified time/date.

In step 104, the mobile unit identifies a nearby roadside controller 14 that is available for processing the sensor data. Any of various well known signaling and handshaking protocols may be used for this identification. For example, the mobile unit may transmit a broadcast signal requesting a response by the nearby controllers, and the nearby controllers available for conducting the processing may then transmit a response indicating their availability. The mobile unit may then select one of the available controllers for transmitting, in step 106, the bundled sensor data with the time/date and location information.

In step 108, the mobile unit receives a wireless notification from the roadside controller. The notification may contain, for example, information on the recognized ID and the reason for the notification.

In step 110, the notification information is conveyed to a user of the mobile unit. In this regard, the notification may be displayed on a display associated with the mobile unit, or output in an audio manner via a speaker associated with the mobile unit.

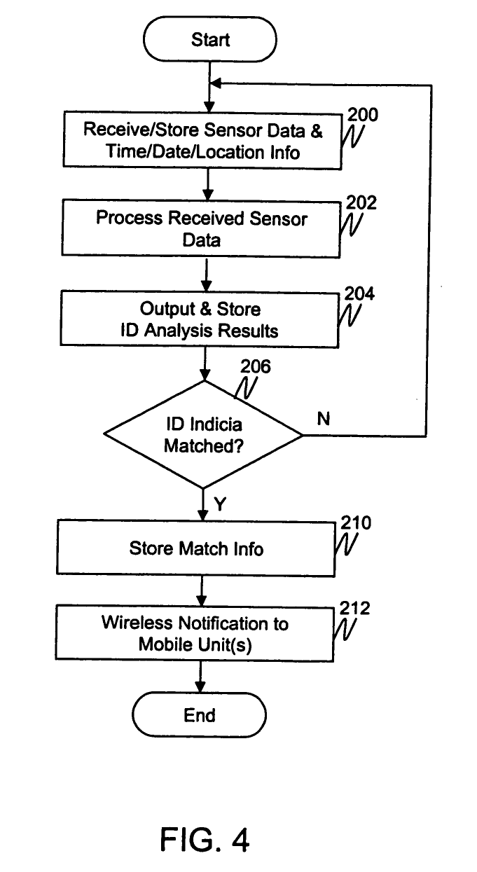

FIG. 4 is a flow diagram of a process executed by the analysis/decision software 26 of the roadside controllers 12 according to one embodiment of the invention. The same process may also be executed by the TMC 14 and/or regional controller 18. A person of skill in the art should also recognize that the routine may be executed via hardware, firmware (e.g. via an ASIC), or in any combination of software, firmware, and/or hardware. Furthermore, the steps of the process may be executed in the indicated order or in any other order recognized by a person of skill in the art.

In step 200, the analysis/decision software 26 receives the sensor data package with the raw sensor data and any transmitted time/date and location information. According to one embodiment of the invention, the received data is stored in a local sensor database 25. The received data may also be forwarded to the TMC 14, and from the TMC to the regional controller 18, for storing in respectively the TMC and regional sensor databases 31, 43.

In step 202, the analysis/decision software 26 processes the received sensor data and attempts to find a match between the sensor data and the ID indicia stored in the criteria database 30. In step 204, results of the ID analysis is stored in the local, TMC, and/or regional results database 29, 35, 42 regardless of whether the analysis successfully matched an entry in the criteria database.

If an ID indicia was matched during the processing of step 202 as is determined in step 206, information about the match is stored, in step 210, in the local, TMC, and/or regional matches database 27, 33, 41. In step 212, the analysis/decision software 26 transmits a notification to the mobile unit with all or part of the match information. The match information may include, for example, a warning or alert posted for the recognized ID.

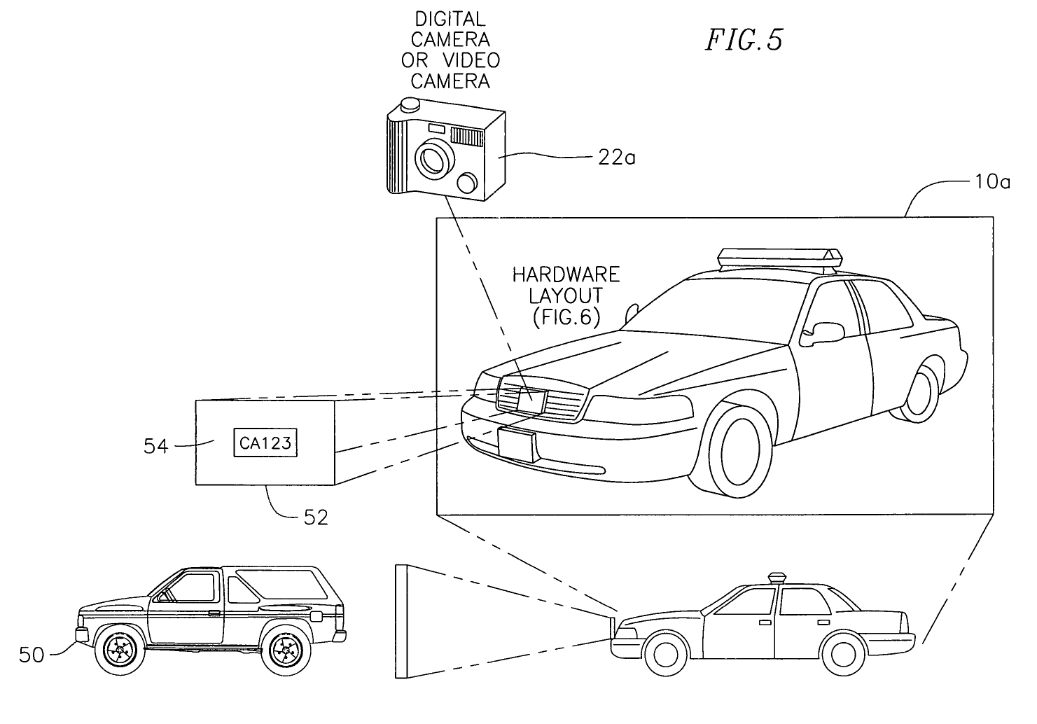

In an exemplary embodiment of the invention, the ID recognition system of FIGS. 1-4 is employed for real-time, in-vehicle license plate recognition. FIG. 5 is a schematic block diagram of a mobile unit configured for such license plate recognition. The mobile unit in the illustrated example takes the form of an enforcement vehicle 10a, such as, for example, a police car. The detection hardware 22 used by the enforcement vehicle to obtain the sensor data is a digital still or video camera 22a.

According to one embodiment of the invention, the camera 22a is programmed to continuously take and forward raw image data to nearby roadside controllers as the enforcement vehicle travels along a road network. In this regard, the camera 22a may be pre-programmed to automatically take pictures at given intervals once it senses that the vehicle is in motion (or active). The camera 22a may also be manually invoked by the enforcement officer to take a picture when desired.

In the illustrated example, the camera 22a is automatically or manually invoked for capturing an image of a vehicle 50 on the road network. The positioning of the camera 22a on the enforcement vehicle allows a photo 52 of the vehicle's license plate 54 to be generated. The enforcement vehicle forwards the obtained image data, as well as the time and date when the image was obtained, and the location of the enforcement vehicle at the identified time, to a nearby roadside controller.

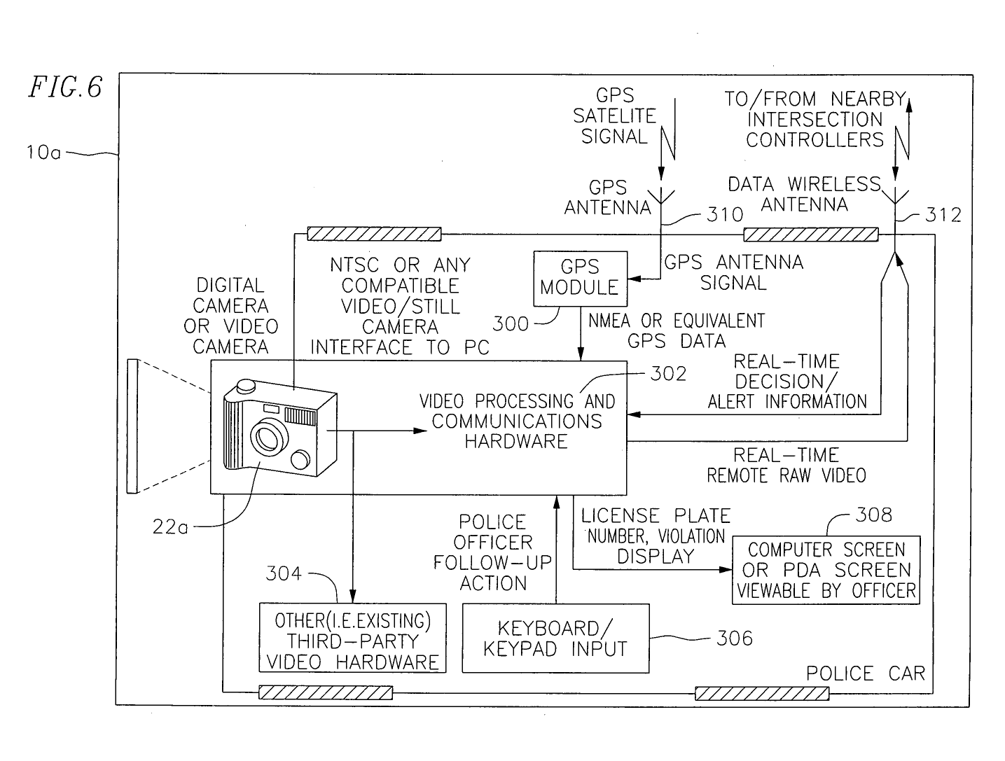

FIG. 6 is a hardware layout of the enforcement vehicle 10a according to one embodiment of the invention. The enforcement vehicle is equipped with a video processing and communications hardware and associated software 302 that receives the images captured by the still or video camera 22a for forwarding to a roadside controller. The captured images may further be transmitted to other third-party video hardware for display, communication to other entities, or the like.

The video processing and communications hardware and associated software further receives location information from a GPS module 300. In this regard, the enforcement vehicle 10a is equipped with a GPS antenna 310 that receives longitude and latitude information from a GPS satellite, and forwards the information to the GPS module 300 for translating into a street address.

The video processing and communications hardware and associated software 302 bundles the image and position information into a package along with any time and/or date information, and forwards the bundled package to an identified roadside controller 12. In this regard, the enforcement vehicle 10a is equipped with an RF antenna 312 for wirelessly transmitting the bundled package to the roadside controller 12.

Any notification transmitted by the roadside controller 12 is received by the RF antenna 312 and forwarded to the video processing and communications hardware and associated software 302. Information transmitted with the notification, such as, for example, a recognized license plate number and violation information is displayed on a display screen 308 coupled to the enforcement vehicle 10a. In response, an officer may follow-up by manually calling into dispatch or by entering, using an input device 306 such as, for example, a keyboard or keypad, a request for additional information on the license plate number and/or violation. Any such request may be transmitted to the roadside controller 12 via the RF antenna, for forwarding to the TMC 14 or regional controller 18.

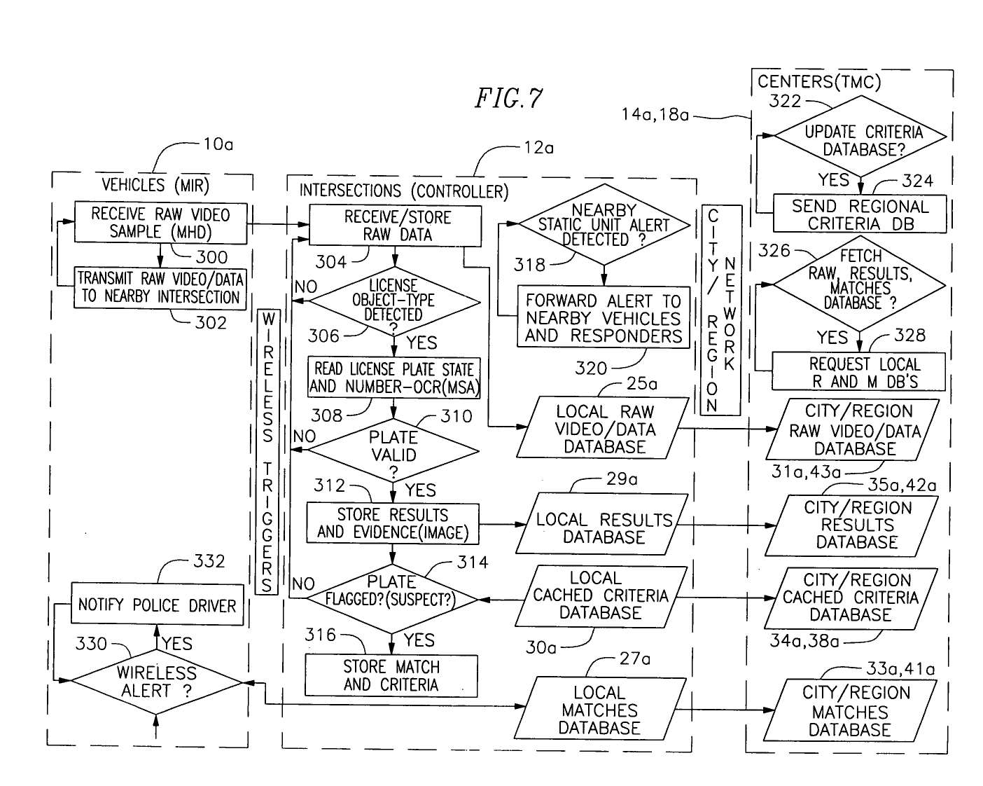

FIG. 7 are flow diagrams of the processes executed by enforcement vehicles 10a, roadside controllers 12a, and city or regional centers 18a for real-time, in-vehicle license plate recognition according to one embodiment of the invention. The roadside vehicles 10a, in step 300, continuously obtain raw image samples when programmed to do so, and in step 302, forward the image samples to a nearby roadside controller 12a, which may be similar to the roadside controller 12 of FIG. 2.

The roadside controller 12a receives and stores the image data in a local image database 25a along with any time, date, and location information of the enforcement vehicle when the image data was obtained.

In step 306, a determination is made as to whether the image data is for a license object-type. This determination may be made, for example, via any of various well known license plate recognition softwares known in the art, which are generally adaptations of the OCR software.

If the answer is YES, the roadside controller, in step 308, invokes the OCR software to identify the license plate state and number, and determines, in step 310, whether the license plate is a valid license plate. This determination is made, for example, by comparing the recognized license plate state and number against a list of valid license plate numbers.

If a valid license plate has been recognized, the results of the recognition are stored, in step 312, in a local results database 29a, along with the image of the license plate as evidence of the recognition.

In step 314, a determination is made as to whether the license plate has been flagged in some local criteria database 30a, due to, for example, a particular violation of the law. If the answer is YES, information on the matching license plate, as well as the violation for which the license plate was flagged, are stored in a local matches database 27a.

The notification is also wirelessly transmitted to the enforcement vehicle. In this regard, in step 330, the emergency vehicle determines if a wireless alert has been received. If the answer is YES, the notification is displayed, in step 332, to the officer of the enforcement vehicle.

According to one embodiment of the invention, the roadside controller is further equipped with a static recognition unit, such as, for example, a red-light running system. Alerts generated by such static recognition units may also be forwarded to the enforcement vehicle in real-time as the alerts are generated. In this regard, in step 318, the roadside controller determines whether a nearby static unit alert is detected. If the answer is YES, the alert is wirelessly forwarded to the enforcement vehicles 10a and to any other subscribing first responders.

In contrast, a traditional static recognition system with no mobile units simply generates reports regarding the detection of suspected license plates. However, no real-time action occurs because such systems include no mechanism to act on the information on a real-time basis. However, in a city where the roadside controller is equipped for real-time, ID recognition and notification, any police vehicle/officer in the vicinity of the controller may be immediately notified upon an alert from an associated static recognition unit. Such real-time notification may allow police to be at the alert scene within seconds. As the suspected vehicle moves along any given street in the city, additional warnings/alerts may be issued by other static units. This may allow the system to triangulate the suspected vehicle and instruct the officer where to drive in real-time. Likewise, as the officers near the vehicle, their mobile units may also be used for detection.

The fixed-static cooperative feature described above may be used in any embodiment of the distributed ID recognition system. Faces of pedestrians may be identified as they walk along crosswalks, and tracked much like vehicles through the real-time notification system. In another example, voices may be detected and mapped based on input from in-situ, static microphones. Furthermore, even when a suspect's face is disguised, officers may use the mobile units to identify a suspect when they close in on the location.

According to one embodiment of the invention, the results in the local sensor/raw database 25a, local criteria database 30a, and local matches database 27a are forwarded for storing in respectively a city/region image database 31a, 43a, criteria database 35a and 42a, and matches databases 33a, 41a maintained by a city and/or regional center 14a, 18a. Such forwarding of the information may be done automatically as the information is obtained by the roadside controller 12a, or by poll request by the city and/or regional center. In the event of such polled request, a determination is made in step 326 as to whether a condition or manual request for polling for the information has been encountered. If the answer is YES, a request to poll the interested databases is transmitted, in step 328, to one or more particularly identified roadside controllers 12a, or to all roadside controllers 12a managed by the city or regional center.

Updates to the local criteria database 30a or local criteria database 30 may be automatically transmitted by the city and regional centers 14a, 18a upon the occurrence of such updates. For example, in updating the local criteria database 30a, a determination is made in step 322 as to whether the update should be made. This made be done, for example, by determining whether any of the data in the city/region criteria database 34a, 38a is marked as being new or changed since a last communication with the roadside controllers 12a. If the update is warranted, the new or updated information is transmitted in step 324.

According to one embodiment of the invention, the data in the ID recognition and match data in the local and city/regional databases may be used for historical analysis and investigation. Suppose, for example, a city's fleet of fifty police vehicles is equipped with the mobile ID recognition capability described above, specifically, with the feature of license plate recognition. Over a period of six months, running the system 24 hours a day, these vehicles may transmit over one million license plate numbers to the roadside controllers. Now suppose that a suspected vehicle was identified as possibly being involved in a murder over the same six-month period. The subscribing agencies for the license plate recognition system may now, in a matter of seconds, search their archive for both the existence of any sightings of the vehicle's license plate and the location and time at which the plate was recorded. Any matches in the system would be supplemented by an actual photograph (the “sample set” evidence) from the OCR match performed at the original intersection. This ongoing log and synthesis of city-wide and regional databases may serve as a powerful tool for many investigative aspects of the enforcement community. A person of skill in the art should recognize that this investigative technique may extend to all other types of ID recognition.

Thus, a comprehensive ID recognition system is provided which allows the functions, processing, and data used for real-time ID recognition to be distributed to preexisting roadside controllers. A lot of the ID recognition (e.g. facial recognition, license plate recognition, etc) generates enormous data volumes for their sampling sets (e.g. video). In order to instantly transmit this huge data stream to a platform capable of both real-time analysis and real-time feedback, the above embodiments re-use the existing roadside infrastructure of traffic intersection controllers as intelligent nodes. The high-density and uniform distribution of these intersections controllers (across city regions) provides the backbone for real-time, high-bandwidth wireless communication and advanced, redundant processing. This drastically reduces the cost, complexity, and maintenance of the mobile units, and allows re-use of expensive fixed infrastructure amongst many subscribing units. Likewise, it allows distributed, yet centrally disseminated, secure control and maintenance of ID criteria and historical databases. The benefits of such a comprehensive recognition system are revolutionary: nationwide real-time criminal enforcement and archived location-based ID investigation.

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A method for identification (ID) recognition via a mobile unit equipped with sensor detection hardware and an intersection controller equipped with sensor processing software, the method comprising:
invoking the sensor detection hardware of the mobile unit for obtaining sensor data;
determining location information for the mobile unit in response to the sensor detection hardware obtaining the sensor data;
wirelessly transmitting by the mobile unit to one or more intersection controllers, the obtained sensor data and the location information;
wirelessly receiving at a particular intersection controller the sensor data and the location information transmitted by the mobile unit;
invoking the sensor processing software at the particular intersection controller for analyzing the received sensor data and outputting ID recognition information; and
storing in a data store coupled to the particular intersection controller, the output ID recognition information in association with the location information.

2. The method of claim 1, wherein the sensor data is a license plate image.

3. The method of claim 1, wherein the sensor data is a facial image.

4. The method of claim 1, wherein the intersection controller controls traffic signals at the intersection.

5. The method of claim 1 further comprising:
programming the sensor detection hardware for continuously obtaining and forwarding the sensor data to the intersection controller under predetermined conditions.

6. The method of claim 1, wherein the analyzing of the received sensor data includes:
searching a notification criteria database for a match of the sensor data with stored ID indicia; and
wirelessly transmitting a notification to the mobile unit responsive to the match.

7. The method of claim 6, wherein the stored ID indicia is a list of license plate numbers, and the notification criteria database further stores violations associated with each stored license plate.

8. The method of claim 7, wherein the notification includes the license plate number matching the sensor data and the associated violation.

9. The method of claim 1, wherein the location information is determined via a global positioning system.

10. A method for identification (ID) recognition via a mobile unit equipped with sensor detection hardware and a roadside controller equipped with sensor processing software, the method comprising:
invoking the sensor detection hardware of the mobile unit for obtaining sensor data;
wirelessly transmitting by the mobile unit to one or more roadside controllers, the obtained sensor data;
wirelessly receiving at a particular roadside controller the sensor data transmitted by the mobile unit;
invoking the sensor processing software at the particular roadside controller for searching a notification criteria database for a match of the sensor data with stored ID indicia; and
wirelessly transmitting a notification to the mobile unit responsive to the match.

11. The method of claim 10, wherein the sensor data is a license plate image.

12. The method of claim 10, wherein the sensor data is a facial image.

13. The method of claim 10, wherein the roadside controller is an intersection controller controlling traffic signals at the intersection.

14. The method of claim 10 further comprising:
programming the sensor detection hardware for continuously obtaining and forwarding the sensor data to the roadside controller under predetermined conditions.

15. The method of claim 10 further comprising:
obtaining position information of the mobile unit; and
transmitting the position information to the roadside controller in association with the sensor data.

16. The method of claim 10, wherein the stored ID indicia is a list of license plate numbers, and the notification criteria database further stores violations associated with each stored license plate.

17. The method of claim 16, wherein the notification includes the license plate number matching the sensor data and the associated violation.

18. An identification (ID) recognition system comprising:
a mobile unit including:
a sensor detection hardware obtaining sensor data;
a global positioning system unit obtaining location of the mobile unit in response to the obtained sensor data; and
a wireless interface for wirelessly transmitting the obtained sensor data and the location information; and
an intersection controller in communication with the mobile unit, the intersection controller including:
a wireless interface for wirelessly receiving the sensor data and the location information transmitted by the mobile unit;
a processor;
a memory operably coupled to the processor and storing sensor data processing instructions, the processor being operable to execute the sensor data processing instructions and output ID recognition information; and
a data store storing the ID recognition information in association with the location information.

19. An intersection controller wirelessly receiving sensor data obtained by a mobile unit, the intersection controller comprising:
a wireless interface for wirelessly communicating with the mobile unit;
a notification criteria database storing a plurality of ID indicia;
a processor; and
a memory operably coupled to the processor and storing program instructions therein, the processor being operable to execute the program instructions, the program instructions including:
controlling traffic signals based on predetermined conditions;
analyzing the sensor data transmitted by the mobile unit;
searching the notification criteria database for a match of the sensor data with the stored ID indicia; and
wirelessly transmitting a notification to the mobile unit responsive to the match.

20. The intersection controller of claim 19, wherein the stored ID indicia is a list of license plate numbers, and the notification criteria database further stores violations associated with each stored license plate.
